(19) United States
(12) Patent Application Publication
(10) Pub. No.: US 2026/0291318 A1
(43) Pub. Date: Sep. 24, 2026

(54) STATOR AND METHOD OF MANUFACTURING STATOR

(71) Applicant: AISIN CORPORATION, Kariya (JP)

(72) Inventor: Yasunori OGURI, Kariya-shi (JP)

(73) Assignee: AISIN CORPORATION, Kariya (JP)

(21) Appl. No.: 19/567,887

(22) Filed: Mar. 16, 2026

(30) Foreign Application Priority Data
Mar. 21, 2025 (JP) 2025-046369

(51) Int. Cl. H02K 3/34; H02K 1/20; H02K 15/026; H02K 15/108; H02K 15/121

(52) U.S. Cl. CPC H02K 3/345; H02K 1/20; H02K 15/026; H02K 15/108; H02K 15/121

(57) ABSTRACT

A stator according to an embodiment includes: an annular stator core having a plurality of teeth arranged in a circumferential direction and protruding radially inward, and a plurality of slots formed between the teeth in the circumferential direction; a coil disposed in the slot; and an insulating member including resin or rubber, surrounding the coil in the slot and fitted into the slot in a press-fitted state. A groove is formed in a facing surface of the insulating member, the facing surface facing a wall surface of the slot, and a space surrounded by an inner surface of the groove and the wall surface of the slot is a refrigerant flow path.

### CROSS REFERENCE TO RELATED APPLICATIONS

This application is based on and claims priority under 35 U.S.C. § 119 to Japanese Patent Application No. 2025-046369, filed on Mar. 21, 2025, the entire content of which is incorporated herein by reference.

### TECHNICAL FIELD

The present disclosure relates to a stator and a method of manufacturing the stator.

### BACKGROUND DISCUSSION

Conventionally, a structure in which an insulating member is provided so as to surround a coil accommodated in a slot of a stator is known (see, for example, Chinese Utility Model No. 220087028). Chinese Utility model No. 220087028 describes that a refrigerant flow path is formed between an inner peripheral surface of the insulating member and the coil. Further, Chinese Utility Model No. 220087028 describes that the insulating member has an accommodation cavity for interference fitting the coil.

In the configuration of Chinese Utility Model No. 220087028, since the refrigerant flow path is formed between the inner peripheral surface of the insulating member and the coil, the contact area between the coil and the insulating member is small, and as a result, there is a possibility that fixation of the coil to the slot becomes weak.

A need thus exists for a stator and a method of manufacturing the same which are not susceptible to the drawback mentioned above.

### SUMMARY

A stator according to an embodiment includes: an annular stator core that has a plurality of teeth that are arranged in a circumferential direction and protrude radially inward, and a plurality of slots that are formed between the plurality of teeth in the circumferential direction; a coil that is disposed in each of the plurality of slots; and an insulating member that includes resin or rubber, surrounds the coil in the each of the plurality of slots and is fitted into the each of the plurality of slots in a press-fitted state, in which a groove is formed in a facing surface of the insulating member, the facing surface facing a wall surface of the each of the plurality of slots, and a space surrounded by an inner surface of the groove and the wall surface of the each of the plurality of slots is a refrigerant flow path.

A method of manufacturing a stator according to an embodiment includes: a molding step of molding an insulating member that includes resin or rubber and surrounds a coil to integrate the coil and the insulating member; a flow path forming step of providing a refrigerant flow path in the insulating member; and an inserting step of inserting the insulating member in which the refrigerant flow path is provided and the coil into each of a plurality of slots of an annular stator core having a plurality of teeth that are arranged in a circumferential direction and protrude radially inward and the plurality of slots that are formed between the plurality of teeth in the circumferential direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a stator;

FIG. 2 is a schematic view of an insulating member and coils in a first embodiment as viewed from a direction perpendicular to both the axial direction and the radial direction;

FIG. 3 is a cross-sectional view taken along line III-III in FIG. 2;

FIG. 4 is a cross-sectional view taken along line IV-IV in FIG. 2;

FIG. 5 is a cross-sectional view taken along line V-V in FIG. 2;

FIG. 6 is a perspective view of a flow path of a stator core, the insulating member, and the coils;

FIG. 7 is a flowchart of a manufacturing procedure of the stator;

FIG. 8 is a view illustrating a plurality of linear coils;

FIG. 9 is a plan view of the stator core;

FIG. 10 is a cross-sectional view of a mold;

FIG. 11 is a side view illustrating the stator core and coil end portions protruding from the stator core;

FIG. 12 is a schematic view of an insulating member and the coils in a second embodiment as viewed from the direction perpendicular to both the axial direction and the radial direction;

FIG. 13 is a schematic view of the insulating member and the coil in the second embodiment as viewed from a direction from a radially inner side to a radially outer side;

FIG. 14 illustrates a cross-section of a slot, the coils, and an insulating member in a third embodiment, the cross section being perpendicular to the axial direction;

FIG. 15 is a cross-sectional view of the slot, the coils, and the insulating member in the third embodiment at a cross section perpendicular to the axial direction and at an axial position different from that in FIG. 14;

FIG. 16 is a cross-sectional view of the slot, the coils, and the insulating member in the third embodiment at a cross section perpendicular to the axial direction and at an axial position different from those in FIGS. 14 and 15;

FIG. 17 illustrates a cross-section of the slot, the coils, and an insulating member in a fourth embodiment, the cross-section being perpendicular to the axial direction; and

FIG. 18 illustrates a cross section of the slot, the coils, and an insulating member in a fifth embodiment, the cross section being perpendicular to the axial direction.

### DETAILED DESCRIPTION

Here, embodiments of the present disclosure will be described in the following order.
(1) First Embodiment:
(1-1) Configuration of Stator:
(1-2) Method of Manufacturing Stator:
(2) Second Embodiment:
(3) Third Embodiment:
(4) Fourth Embodiment:
(5) Fifth Embodiment:
(6) Other Embodiments:

### First Embodiment

### (1-1) Configuration of Stator:

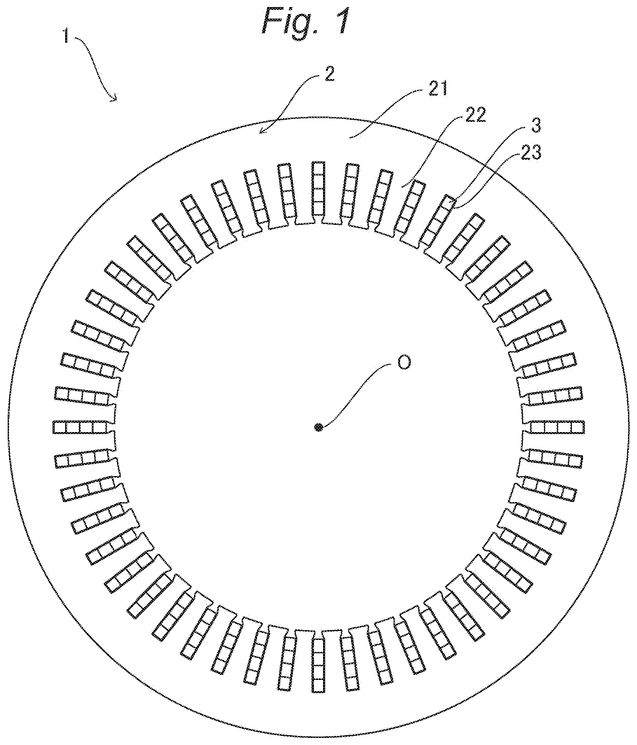

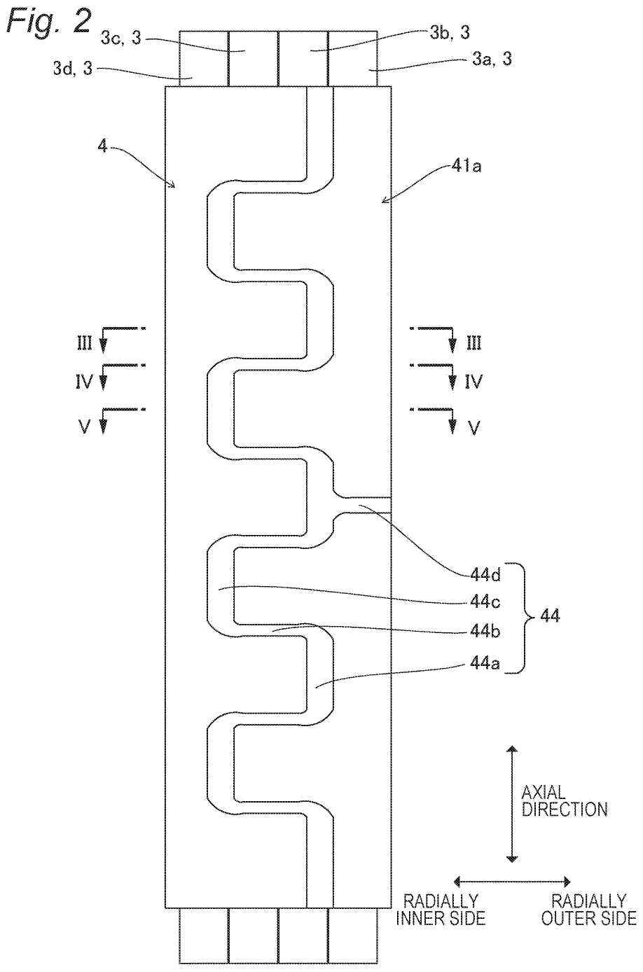

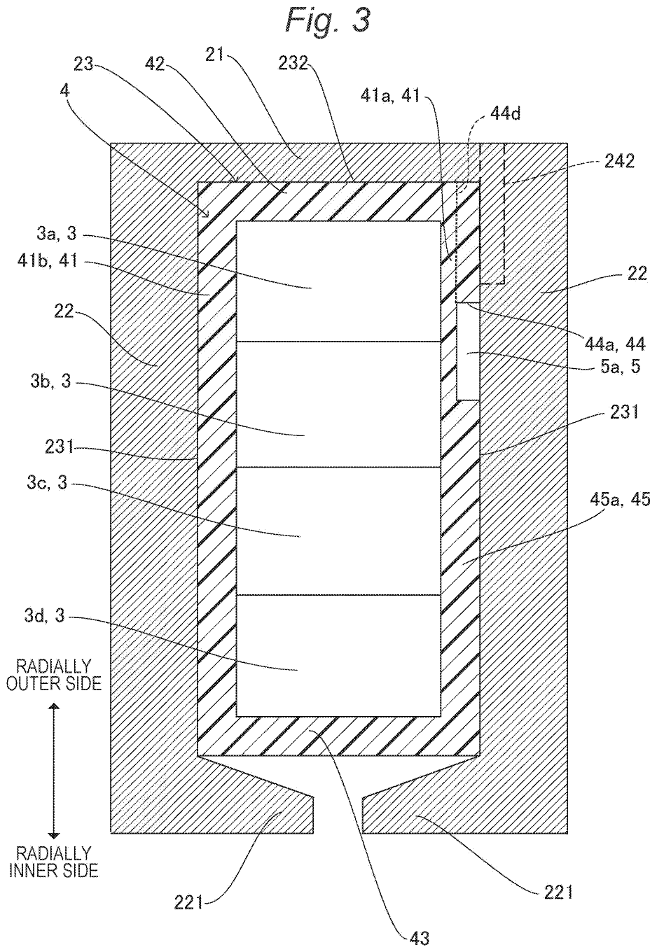

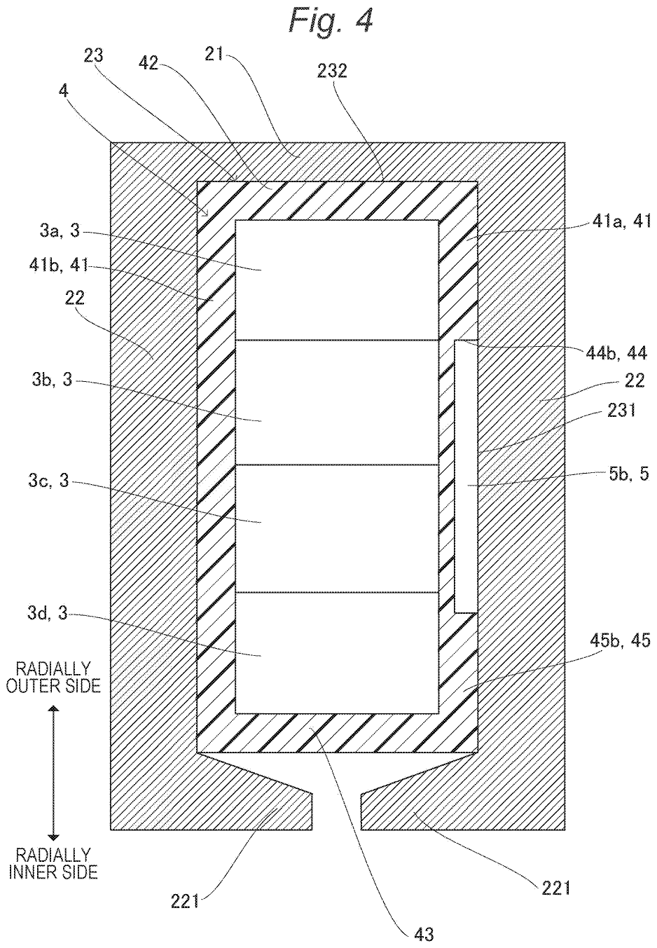

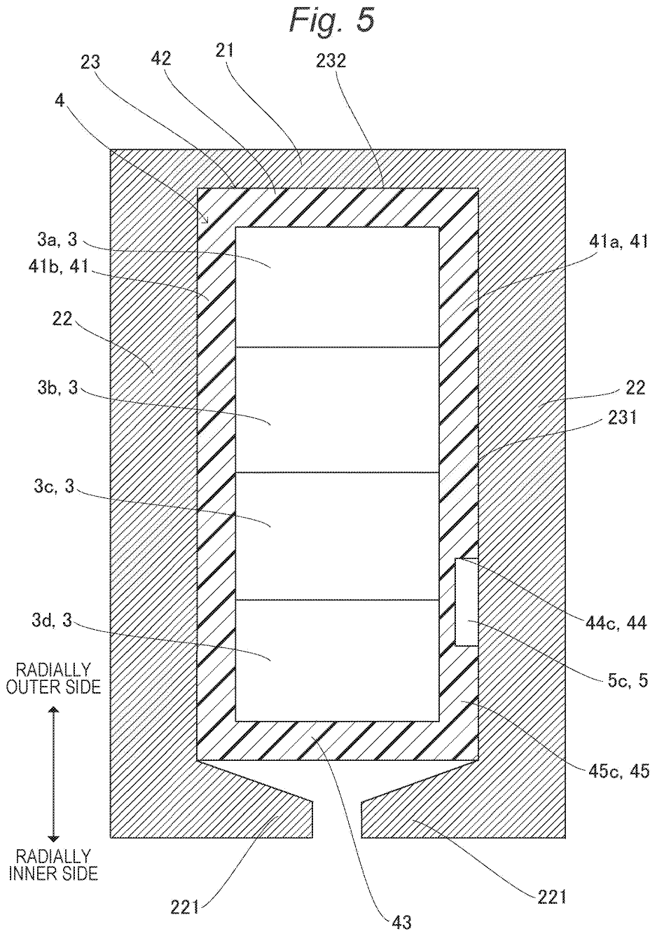

FIG. 1 is a plan view of a stator 1 according to the present embodiment. Hereinafter, a direction parallel to a central axis which is a straight line passing through a center O of a stator core 2 described later and perpendicular to the paper surface of FIG. 1 is referred to as an axial direction. In addition, a direction along the circumference of a circle centered on the central axis is referred to as a circumferential direction, and a direction parallel to the radius of the circle is referred to as a radial direction. Furthermore, in the radial direction, a direction approaching the central axis is referred to as a radially inner side and a direction away from the central axis is referred to as a radially outer side. FIG. 2 is a schematic view of an insulating member 4 and coils 3 surrounded by the insulating member 4 according to the present embodiment when the insulating member 4 and the coils 3 are viewed from a direction perpendicular to both the axial direction and the radial direction. FIG. 3 is a cross-sectional view taken along line III-III in FIG. 2. FIG. 4 is a cross-sectional view taken along line IV-IV in FIG. 2. FIG. 5 is a cross-sectional view taken along line V-V in FIG. 2. Note that in FIGS. 1 and 2, coil end portions, which are portions of the coil 3 that are not accommodated in the stator core 2, are cut in a direction perpendicular to the axial direction. In FIGS. 3 to 5, a slot 23 is also illustrated. In FIGS. 2 to 5, the slot 23, the insulating member 4, the coils 3, and the like are schematically illustrated for easy understanding, and the shape or dimension of each portion in FIGS. 2 to 5 may be different from the actual shape or dimension.

The stator 1 is a stator of a rotary electric machine. The rotary electric machine to which the stator 1 is applied is, for example, a synchronous motor. The rotary electric machine to which the stator 1 is applied is of an inner rotor type. That is, the rotary electric machine includes the stator 1 and a rotor, not illustrated, provided inside the stator 1. The stator 1 is a member for forming a magnetic pole in a tooth 22 to be described later and forming a rotating magnetic field in which the polarity (N pole, S pole) of the magnetic pole changes with time. The rotor is provided so as to be rotatable about the central axis. The rotor forms a magnetic pole on the outer periphery thereof. The rotor rotates by the action of the magnetic pole of the rotor and the magnetic pole of the stator 1. The stator 1 and the rotor are accommodated in a case, not illustrated.

The stator 1 includes the stator core 2, the coils 3, and the insulating member 4. The stator core 2 is an annular member. The stator core 2 is a laminate formed by stacking in the axial direction a plurality of electromagnetic steel sheets (for example, silicon steel sheets) formed in a substantially annular shape by, for example, press working. Alternatively, the stator core 2 may be a powder magnetic core formed by press-molding magnetic particles. The stator core 2 includes an annular core body 21, the plurality of teeth 22 arranged in the circumferential direction and protruding radially inward from an inner peripheral surface of the core body 21, and a plurality of slots 23 formed between the teeth 22 in the circumferential direction.

The teeth 22 are formed at regular intervals in the circumferential direction on the entire circumference of the inner peripheral surface of the core body 21. The number of teeth 22 may be various. In the present embodiment, the cross-sectional shape of the tooth 22 in the direction perpendicular to the axial direction is the same at any position in the axial direction. Therefore, the tooth 22 is a section that protrudes radially inward and extends in the axial direction in a state where the cross-sectional shape in the direction perpendicular to the axial direction is the same. The teeth 22 have the same shape. The distal end of the tooth 22 in the radial direction has an overhang portion 221 overhanging on both sides in the circumferential direction (see FIGS. 3 to 5). The overhang portions 221 of two adjacent teeth 22 face each other at an interval in the circumferential direction.

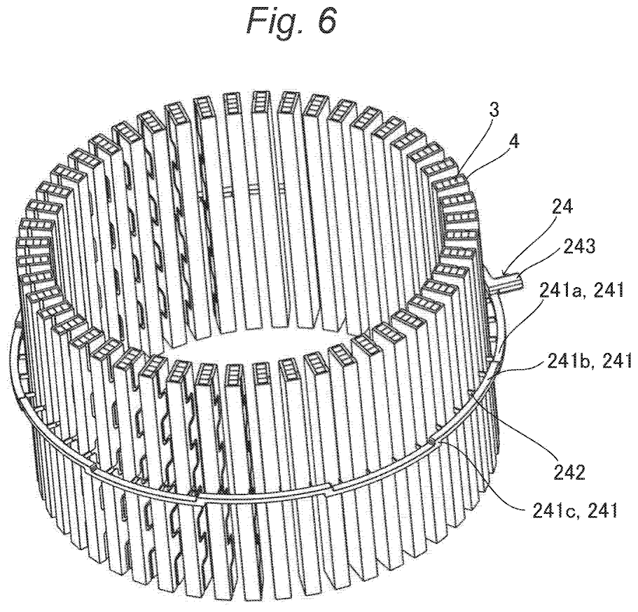

The slot 23 is a space formed between the teeth 22 in the circumferential direction for accommodating the coils 3. The plurality of slots 23 arranged in the circumferential direction have the same shape. The slot 23 penetrates the stator core 2 in the axial direction. The slot 23 forms an opening on the radially inner side. This opening is formed between two adjacent overhang portions 221. The cross-sectional shape of the slot 23 in the direction perpendicular to the axial direction is the same at any position in the axial direction. Note that a central portion which is a portion at a central position in the axial direction, of the slot 23 is connected to a refrigerant flow path 242 (see FIGS. 3 and 6) formed in the stator core 2. The shape of the central portion of the slot 23 may be different from the shape of a portion other than the central portion of the slot 23. The central position means a position that divides the slot 23 into approximately two equal parts in the axial direction.

As illustrated in FIG. 3, the slot 23 includes two side surfaces 231 which are wall surfaces extending in the radial direction and a back surface 232 which is a wall surface connecting end portions of the two side surfaces 231 on the radially outer side when viewed from the axial direction. Hereinafter, the side surface 231 may be referred to as a slot side surface. The back surface 232 may be referred to as a slot back surface. The slot side surface 231 constitutes part of the side surface of the tooth 22. The two slot side surfaces 231 are provided in parallel to each other. The slot back surface 232 constitutes part of the inner peripheral surface of the core body 21. A space surrounded by the two slot side surfaces 231 and the slot back surface 232 is an accommodation space for the coils 3. The width of the slot side surface 231 in the radial direction may be larger than the width between the two slot side surfaces 231, in other words, the width of the slot back surface 232 when viewed from the axial direction.

The slot 23 opens radially inward. The opening width, that is, the width between the overhang portions 221 of the teeth 22 is smaller than the width between the two slot side surfaces 231. Note that the radially inner opening of the slot 23 may be sealed by another member (not illustrated) or may not be sealed.

The stator core 2 has a flow path 24 (see FIG. 6) for supplying a refrigerant to the central portion in the axial direction of each slot 23. In FIG. 6, the flow path 24 is extracted from the stator core 2 and illustrated. The flow path 24 is provided at the central position in the axial direction. The flow path 24 includes a circumferential flow path 241 extending in the circumferential direction. The circumferential flow path 241 includes a first circumferential flow path 241a and a second circumferential flow path 241b provided at an axial position different from that of the first circumferential flow path 241a. The plurality of first circumferential flow paths 241a are provided at intervals in the circumferential direction. The plurality of second circumferential flow paths 241b are provided at intervals in the circumferential direction. The first circumferential flow path 241a and the second circumferential flow path 241b are alternately arranged in the circumferential direction. In a case where the stator core 2 is a laminate of a plurality of electromagnetic steel sheets, the first circumferential flow path 241a and the second circumferential flow path 241b are formed in electromagnetic steel sheets different from each other.

The circumferential flow path 241 includes a connecting flow path 241c that connects the first circumferential flow path 241a and the second circumferential flow path 241. The connecting flow path 241c connects the circumferential end portions of the circumferential flow paths 241a and 242b. The flow path 24 includes the plurality of radial flow paths 242 extending radially from the circumferential flow path 241. As many radial flow paths 242 as the number of slots 23 are provided. Each radial flow path 242 forms an opening in the wall surface of each slot 23 at the central position in the axial direction. In the present embodiment, the radial flow path 242 forms an opening in the slot side surface 231. This opening is formed only in the central portion of the slot 23 in the axial direction, that is, the opening does not extend in the axial direction. In addition, the flow path 24 includes a connecting flow path 243 that connects an external flow path (not illustrated) and the circumferential flow path 241. Since the flow path 24 is configured as described above, it is possible to prevent the stator core 2 from being divided into a plurality of portions in the radial direction or the circumferential direction.

The plurality of coils 3 are arranged side by side in the radial direction in the space surrounded by the slot side surfaces 231 and the slot back surface 232. The number of coils 3 arranged in the radial direction is not limited, but is four in the present embodiment. The coil 3 is a distributed winding. The coil 3 includes an accommodated portion disposed in the slot 23 and the coil end portions protruding in the axial direction from end surfaces of the stator core 2. The accommodated portion of the coil 3 extends linearly in the axial direction. Each coil end portion is connected to the coil end portion of the coil 3 accommodated in another slot 23 by welding or the like. In the present embodiment, the coil 3 is a square wire having a square cross section, but may be a round wire having a circular cross section. For example, any phase in three-phase alternating current is connected to each coil 3. As a result, each coil 3 generates a magnetic pole whose polarity changes with the lapse of time in each tooth 22. The accommodated portion of the coil 3 is fixed to the wall surface of the slot 23 with the insulating member 4 interposed therebetween.

The insulating member 4 is provided for each slot 23 and is provided so as to surround the accommodated portions of the coils 3 in the slot 23. In the present embodiment, entirety of the insulating member 4 includes the same resin. The insulating member 4 includes, for example, a thermoplastic resin, but may include a thermosetting resin. The hardness of the insulating member 4 is desirably a hardness with which the insulating member 4 is not damaged when the insulating member 4 is press-fitted into the slot 23 in the axial direction.

The insulating member 4 is disposed between the outer peripheral surfaces of the coils 3 and the slot side surfaces 231, the slot back surface 232 and the radially inner opening of the slot 23. The insulating member 4 is disposed so as to collectively surround all the coils 3 disposed in one slot 23. The insulating member 4 is formed in a rectangular frame shape when viewed from the axial direction in accordance with the shape of the slot 23 and the outer peripheral shape of the coil 3. The insulating member 4 has, for example, a length equivalent to the entire width of the slot 23 in the axial direction, but may be formed longer than the entire width of the slot 23. The outer width of the insulating member 4 in the cross section perpendicular to the axial direction is, for example, the same at any position in the axial direction.

The insulating member 4 includes two side surface portions 41, a back surface portion 42, and a front surface portion 43. Each side surface portion 41 is provided at a position facing the slot side surface 231. The two side surface portions 41 are provided in parallel to each other. The back surface portion 42 is a portion connecting the radially outer end portions of the side surface portions 41, and is provided at a position facing the slot back surface 232. The back surface portion 42 is provided radially outside the coils 3. The front surface portion 43 is a portion connecting the radially inner end portions of the side surface portions 41, and is provided at a position facing the radially inner opening of the slot 23, in other words, the overhang portions 221 of the teeth 22. The front surface portion 43 is provided radially inside the coils 3.

The insulating member 4 is fitted into the slot 23 in a press-fitted state. That is, one side surface portion 41a is in contact with one of the slot side surfaces 231 in a state of applying pressure thereto. The other side surface portion 41b is in contact with the other slot side surface 231 in a state of applying pressure thereto. The back surface portion 42 is in contact with the slot back surface 232 in a state of applying pressure thereto. The front surface portion 43 is in contact with the overhang portions 221 in a state of applying pressure thereto. As described above, in the present embodiment, the insulating member 4 is provided in a press-fitted state in a direction perpendicular to both the axial direction and the radial direction, that is, in the left-right direction in FIGS. 3 to 5, and is provided in a press-fitted state in the radial direction. However, it is sufficient if the insulating member 4 is provided in a press-fitted state in at least one of the direction perpendicular to both the axial direction and the radial direction and the radial direction. “Fitted in a press-fitted state” means that the insulating member 4 and the coils 3 surrounded by the insulating member 4 are inserted into the slot 23 in a state where such a pressure that does not move the coil 3 in the axial direction with respect to the slot 23 is applied to the wall surfaces of the slot 23. In addition, “fitted in a press-fitted state” means that fitting between the insulating member 4 and the slot 23 is, for example, an interference fit. However, if the insulating member 4 and the coils 3 are fixed to the slot 23, fitting other than the interference fit, for example, light press-fitting, pressing, driving, or the like in a transition fit may be included in the concept of “fitted in a press-fitted state”.

In the present embodiment, entirety of the one side surface portion 41a except for a groove 44 to be described later is in contact with the one of the slot side surfaces 231. Entirety of the other side surface portion 41b is in contact with the other slot side surface 231. Entirety of the back surface portion 42 is in contact with the slot back surface 232. However, the present disclosure is not limited thereto, and as long as the insulating member 4 is fixed to the wall surface of the slot 23, part of the one side surface portion 41a may be in contact with the slot side surface 231, part of the other side surface portion 41b may be in contact with the slot side surface 231, or part of the back surface portion 42 may be in contact with the slot back surface 232. Note that the side surface portions 41 and the back surface portion 42 are directly in contact with the slot side surfaces 231 and the slot back surface 232. That is, no other member such as an adhesive is interposed between the side surface portions 41 and the back surface portion 42 and the slot side surfaces 231 and the slot back surface 232. However, the present disclosure is not limited thereto, and for example, an adhesive may be interposed between the side surface portions 41 and the back surface portion 42 and the slot side surfaces 231 and the slot back surface 232. That is, the side surface portions 41 and the back surface portion 42 may be fixed to the slot side surfaces 231 and the slot back surface 232 with an adhesive in addition to pressure by press-fitting.

An inner peripheral surface of the insulating member 4, which is a surface on the coil 3 side, is fixed to outer peripheral surfaces of the coils 3. Specifically, the entire inner peripheral surface of the one side surface portion 41a is fixed to one side surfaces of the coils 3. The entire inner peripheral surface of the other side surface portion 41b is fixed to the other side surfaces of the coils 3. The entire inner peripheral surface of the back surface portion 42 is fixed to the radially outer surface of a coil 3a located on the outermost side in the radial direction. The entire inner peripheral surface of the front surface portion 43 is fixed to the radially inner surface of a coil 3d located on the radially innermost side. However, the present disclosure is not limited thereto, and it is sufficient if the insulating member 4 can fix the four coils 3. As long as the four coils 3 can be fixed, part of the inner peripheral surface of the one side surface portion 41a may be fixed to the outer peripheral surfaces of the coils 3. Part of the inner peripheral surface of the other side surface portion 41b may be fixed to the outer peripheral surfaces of the coils 3. Part of the inner peripheral surface of the back surface portion 42 may be fixed to the outer peripheral surface of the coil 3a. Part of the inner peripheral surface of the front surface portion 43 may be fixed to the outer peripheral surface of the coil 3d.

The groove 44 is formed in a facing surface of the insulating member 4, the facing surface facing the wall surface of the slot 23. Specifically, the groove 44 is formed in a facing surface of the one side surface portion 41a, the facing surface facing the slot side surface 231. In the present embodiment, the groove 44 is a bottomed groove that does not penetrate between the facing surface that is the surface on the slot side surface 231 side of the side surface portion 41a and the inner peripheral surface that is the surface on the coil 3 side of the side surface portion 41a. As illustrated in FIG. 2, the groove 44 meanders. Specifically, the groove 44 has a shape in which a first part 44a extending in parallel with the axial direction, a second part 44b extending in parallel with the radial direction from an end portion of the first part 44a, and a third part 44c extending in parallel with the axial direction from an end portion of the second part 44b opposite to an end portion to which the first part 44a is connected are repeated along the axial direction. With reference to the second part 44b, the extending direction of the first part 44a from the second part 44b and the extending direction of the third part 44c from the second part 44b are opposite to each other. The direction in which the groove 44 extends while meandering is the axial direction.

Hereinafter, among the four coils 3, the coil 3a located on the outermost side in the radial direction may be referred to as a first coil, a coil 3b located next to the first coil 3a may be referred to as a second coil, a coil 3c located next to the second coil 3b may be referred to as a third coil, and the coil 3d located next to the third coil 3c may be referred to as a fourth coil. In addition, the direction perpendicular to both the axial direction and the radial direction may be simply referred to as a perpendicular direction. As illustrated in FIG. 3, the first part 44a faces at least the first coil 3a in the perpendicular direction. In the present embodiment, the first part 44a is provided so as to straddle the first coil 3a and the second coil 3b in the radial direction. Specifically, part of the first part 44a in the radial direction faces, in the perpendicular direction, part of the first coil 3a on the second coil 3b side in the radial direction. The remaining part of the first part 44a in the radial direction faces, in the perpendicular direction, part of the second coil 3b on the first coil 3a side in the radial direction. The first part 44a does not face the third coil 3c and the fourth coil 3d.

As illustrated in FIG. 4, the second part 44b faces at least the second coil 3b and the third coil 3c in the perpendicular direction. That is, the second part 44b is provided so as to straddle the second coil 3b and the third coil 3c in the radial direction. In the present embodiment, the second part 44b faces, in the perpendicular direction, substantially the entire second coil 3b in the radial direction and substantially the entire third coil 3c in the radial direction. Note that the second part 44b may face, in the perpendicular direction, at least part of the first coil 3a in the radial direction or at least part of the fourth coil 3d in the radial direction.

As illustrated in FIG. 5, the third part 44c faces at least the fourth coil 3d in the perpendicular direction. In the present embodiment, the third part 44c is provided so as to straddle the third coil 3c and the fourth coil 3d in the radial direction. Specifically, part of the third part 44c in the radial direction faces, in the perpendicular direction, part of the third coil 3c on the fourth coil 3d side in the radial direction. The remaining part of the third part 44c in the radial direction faces, in the perpendicular direction, part of the fourth coil 3d on the third coil 3c side in the radial direction. The third part 44c does not face the first coil 3a and the second coil 3b.

As described above, the combined shape of the first part 44a, the second part 44b, and the third part 44c extends across all the coils 3 in the radial direction, in other words, faces all the coils 3 in the perpendicular direction. As long as the combined shape of the first part 44a, the second part 44b, and the third part 44c extends across all the coils 3 in the radial direction, the radial widths of the first part 44a, the second part 44b, and the third part 44c may be arbitrarily set. In addition, the interval between two second part 44b adjacent to each other in the axial direction may be arbitrarily set. The axial width of the first part 44a, the axial width of the second part 44b, and the axial width of the third part 44c may be arbitrarily set.

The groove 44 is provided over the entire range of the insulating member 4 in the axial direction. In the present embodiment, as illustrated in FIG. 2, the first parts 44a are connected to both end portions of the insulating member 4 in the axial direction. However, the present disclosure is not limited thereto, and the third part 44c may be connected to at least one of the end portions of the insulating member 4 in the axial direction.

Further, the groove 44 extends in the axial direction, and includes an introduction portion 44d (see FIGS. 2 and 3) into which the refrigerant from the stator core 2 is introduced at an intermediate position between one end and the other end of the groove 44 in the axial direction. The introduction portion 44d is provided at the central position that divides the slot 23 into approximately two equal parts in the axial direction. The introduction portion 44d is connected to the radial flow path 242 of the stator core 2. In the present embodiment, the introduction portion 44d extends in the radial direction in the one side surface portion 41a. The introduction portion 44d is formed so as to penetrate between the first part 44a and the surface of the back surface portion 42 on the slot back surface 232 side. The introduction portion 44d is formed as, for example, a bottomed groove that does not penetrate between the surface of the side surface portion 41a on the slot side surface 231 side and the surface of the side surface portion 41a on the coil 3 side.

As illustrated in FIGS. 3 to 5, a space surrounded by the inner surfaces of the groove 44 and the wall surface of the slot 23, specifically, the slot side surface 231 is a refrigerant flow path 5. The flow path 5 includes a first flow path 5a, a second flow path 5b, and a third flow path 5c. The first flow path 5a is a space surrounded by the inner surfaces of the first part 44a and the slot side surface 231. The second flow path 5b is a space surrounded by the inner surfaces of the second part 44b and the slot side surface 231. The third flow path 5c is a space surrounded by the inner surfaces of the third part 44c and the slot side surface 231. The first flow path 5a extends in parallel with the axial direction. The second flow path 5b extends in parallel with the radial direction. The third flow path 5c extends in parallel with the axial direction. Note that in the present embodiment, no refrigerant flow path is provided between the coil 3 side surface of the insulating member 4 and the coil 3.

As illustrated in FIGS. 3 to 5, the one side surface portion 41a includes a side surface inner portion 45 provided on the radially inner side of the groove 44. A facing surface of the side surface inner portion 45, the facing surface facing the slot side surface 231 is in contact with the slot side surface 231. Specifically, the side surface portion 41a includes the side surface inner portion 45 at any position in the axial direction where the groove 44 is formed. More specifically, as illustrated in FIG. 3, the side surface inner portion 45 includes a first side surface inner portion 45a provided on the radially inner side of the first part 44a of the groove 44 at the axial position where the first part 44a is formed. The facing surface of the first side surface inner portion 45a on the slot side surface 231 side is in contact with the slot side surface 231 at any position in the axial direction where the first part 44a is formed. In the present embodiment, the entire first side surface inner portion 45a in the radial direction is in contact with the slot side surface 231, but part of the first side surface inner portion 45a in the radial direction may be in contact with the slot side surface 231. Further, at the axial position where the first side surface inner portion 45a is provided, in the facing surface of the side surface portion 41a on the slot side surface 231 side, another groove serving as a refrigerant flow path is not formed on the radially inner side of the first side surface inner portion 45a.

As illustrated in FIG. 4, the side surface inner portion 45 includes a second side surface inner portion 45b provided on the radially inner side of the second part 44b of the groove 44 at the axial position where the second part 44b is formed. The facing surface of the second side surface inner portion 45b on the slot side surface 231 side is in contact with the slot side surface 231 at any position in the axial direction where the second part 44b is formed. In the present embodiment, the entire second side surface inner portion 45b in the radial direction is in contact with the slot side surface 231, but part of the second side surface inner portion 45b in the radial direction may be in contact with the slot side surface 231. Further, at the axial position where the second side surface inner portion 45b is provided, in the facing surface of the side surface portion 41a on the slot side surface 231 side, another groove serving as a refrigerant flow path is not formed on the radially inner side of the second side surface inner portion 45b.

As illustrated in FIG. 5, the side surface inner portion 45 includes a third side surface inner portion 45c provided on the radially inner side of the third part 44c of the groove 44 at the axial position where the third part 44c is formed. The facing surface of the third side surface inner portion 45c on the slot side surface 231 side is in contact with the slot side surface 231 at any position in the axial direction where the third part 44c is formed. In the present embodiment, the entire third side surface inner portion 45c in the radial direction is in contact with the slot side surface 231, but part of the third side surface inner portion 45c in the radial direction may be in contact with the slot side surface 231. Further, at the axial position where the third side surface inner portion 45c is provided, in the facing surface of the side surface portion 41a on the slot side surface 231 side, another groove serving as a refrigerant flow path is not formed on the radially inner side of the third side surface inner portion 45c.

In this manner, the groove 44 and the space on the radially inner side of the coils 3 are blocked by the side surface inner portion 45. As a result, the likelihood that the refrigerant flowing through the groove 44 leaks into the space radially inside the coils 3 can be reduced, in other words, the likelihood that the refrigerant leaks to the outside of the stator 1 can be reduced.

In the other side surface portion 41b and the front surface portion 43, no groove serving as a refrigerant flow path is formed. No groove serving as a refrigerant flow path is formed in the back surface portion 42 except for the introduction portion 44d at the central position in the axial direction.

Next, a flow of the refrigerant will be described. Note that the refrigerant is, for example, oil such as lubricating oil or hydraulic oil, but may be another liquid or gas. The refrigerant sent out by a pump, not illustrated, is cooled by a heat exchanger, not illustrated, and then supplied to the flow path 24 of the stator core 2. The refrigerant supplied to the flow path 24 flows through the connecting flow path 243, the circumferential flow path 241, and each radial flow path 242 illustrated in FIG. 6 in this order, and then is supplied to the introduction portion 44d of the groove 44 provided at the central portion of each slot 23 in the axial direction. The refrigerant supplied to the introduction portion 44d is divided into one side and the other side in the axial direction, and flows while meandering in the first part 44a, the second part 44b, and the third part 44c of the groove 44. Thereafter, the refrigerant flows out of the stator core 2 from both sides in the axial direction. The refrigerant that has flowed out flows through the external flow path, not illustrated, and then returns to the pump.

### (1-2) Method of Manufacturing Stator:

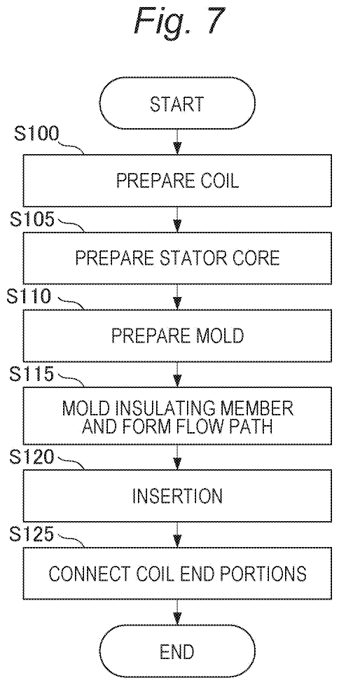

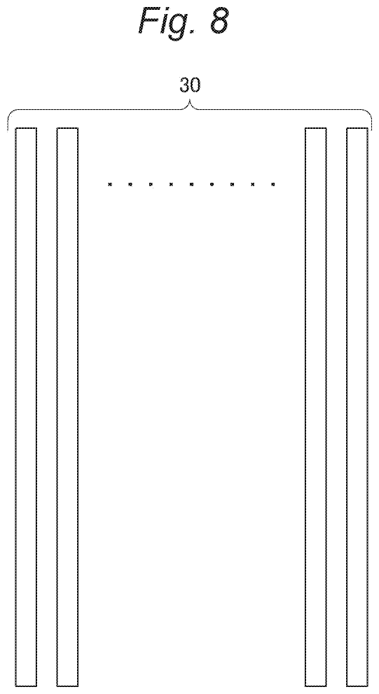

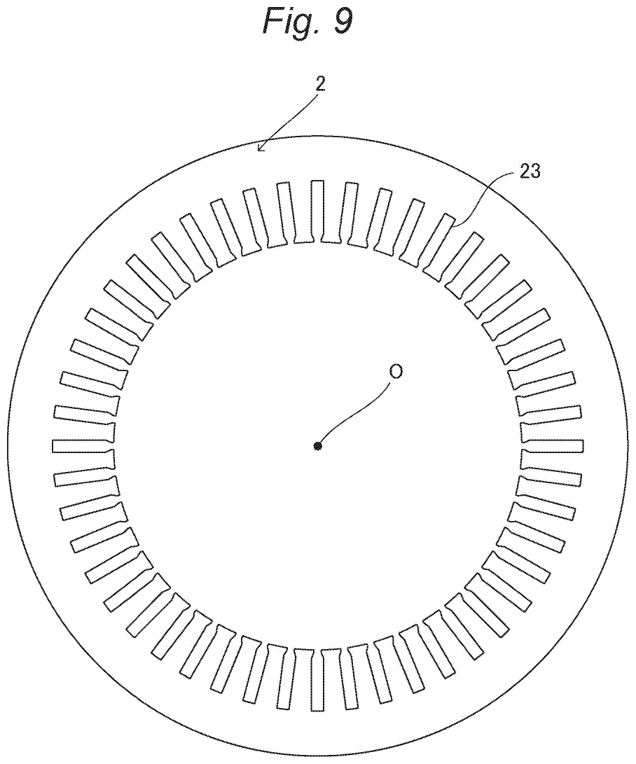

Next, a method of manufacturing the stator 1 will be described. FIG. 7 is a flowchart illustrating a manufacturing procedure of the stator 1. First, as illustrated in FIG. 8, coils 30, which are linear conductive wires serving as base materials of the coils 3 are prepared (step S100). At least as many coils 30 as (the number of coils accommodated in one slot 23)×(the number of slots 23) are prepared. Each coil 30 has an insulating film on the outer peripheral surface. Next, as illustrated in FIG. 9, the stator core 2 is prepared (step S105).

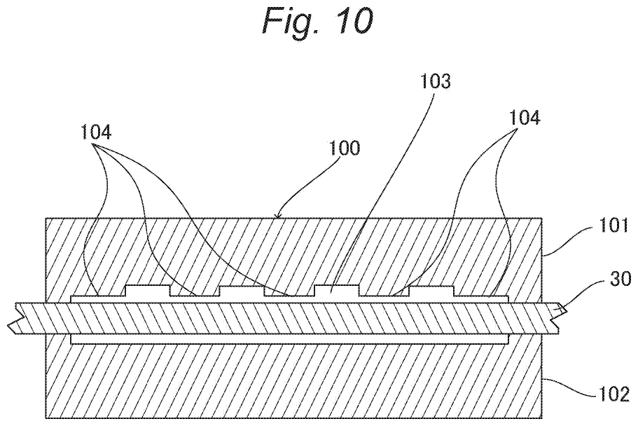

Next, as illustrated in FIG. 10, a mold 100 for molding the insulating member 4 is prepared (step S110). The mold 100 illustrated in FIG. 10 includes an upper mold 101 and a lower mold 102. The upper mold 101 and the lower mold 102 form a cavity 103 in a mold-closed state. The cavity 103 includes a region where the four coils 30 are arranged and a region for molding the insulating member 4 around the region. A surface of the upper mold 101 on the cavity 103 side has protrusions 104 for forming the groove 44. Note that steps S100, S105, and S110 may be executed in any order. Further, step S105 may be executed after step S115 described later.

Next, the insulating member 4 is molded so as to surround the coils 30 (step S115). Specifically, the four coils 30 are positioned on the lower mold 102 or the upper mold 101 in the mold-opened state in a state of being aligned in a direction perpendicular to the axes of the coils 30 such that the axes are parallel to each other. Thereafter, the upper mold 101 and the lower mold 102 are closed. FIG. 10 illustrates a state in which the mold is closed and the coil 30 is disposed in the cavity 103. Thereafter, the region of the cavity 103 around the coils 30 is filled with a resin melted by heating. Thereafter, the filled resin is cooled and cured. Thereafter, the upper mold 101 and the lower mold 102 are opened. Thereafter, the coils 30 and the insulating member 4, which is a resin molded around the coils 30 are taken out from the upper mold 101 or the lower mold 102. As a result, the insulating member 4 integrated with the four coils 30 and having the groove 44 serving as the refrigerant flow path is molded. At least as many insulating members 4 as the number of slots 23 are molded. Note that in step S115, at the same time when the insulating member 4 is molded, the groove 44 as a refrigerant flow path provided in the insulating member 4 is formed. That is, step S115 corresponds to a molding step and a flow path forming step. In step S115, the insulating member 4 is molded by injection molding. In addition, in step S115, the coils 30 and the insulating member 4 are integrated by insert molding.

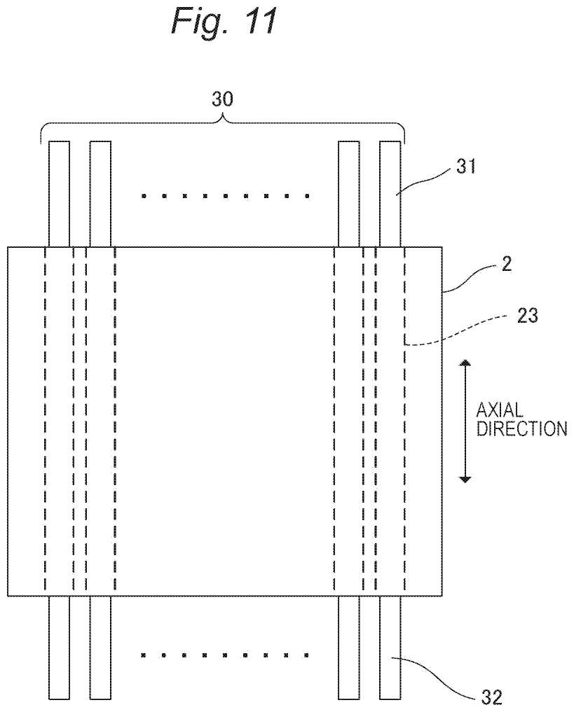

Next, the four coils 30 and the insulating member 4 that are integrated are inserted into the slot 23 from the axial direction of the stator core 2 (step S120). At this time, the four coils 30 and the insulating member 4 are inserted into the slot 23 such that the axes of the coil 30 are parallel to the axial direction of the stator core 2. Specifically, the four coils 30 and the insulating member 4 are press-fitted into the slot 23. Fitting between the insulating member 4 and the slot 23 at this time is set to, for example, an interference fit. In step S120, the four coils 30 and the insulating member 4 are inserted for each slot 23. As illustrated in FIG. 11, in a state where insertion of the coils 30 and the insulating member 4 into the slot 23 is finished, a first coil end portion 31, which is part of each coil 30 from one end portion in the axial direction, protrudes from one end surface of the stator core 2 in the axial direction. A second coil end portion 32, which is part of each coil 30 from the other end portion in the axial direction protrudes from the other end surface of the stator core 2 in the axial direction. Note that step S120 corresponds to an inserting step of the present disclosure.

Next, each of the first coil end portions 31 is bent and connected to another first coil end portion 31 protruding from another slot 23 by welding or the like (step S125). Each of the second coil end portions 32 is bent and connected to another second coil end portion 32 protruding from another slot 23 by welding or the like (step S125). The coils 30 in which the first coil end portions 31 are connected to each other and the second coil end portions 32 are connected to each other are the coils 3 of the stator 1.

Hereinafter, effects of the present embodiment will be described. According to the present embodiment, the groove 44 is formed in the facing surface on the slot side surface 231 side of the one side surface portion 41a of the insulating member 4. Since the space surrounded by the inner surfaces of the groove 44 and the slot side surface 231 is the refrigerant flow path 5, the likelihood that the coils 3 are efficiently cooled can be increased. In addition, since the groove 44 is formed in the facing surface of the side surface portion 41a on the slot side surface 231 side, it is easy to secure the contact area between the insulating member 4 and the coils 3. As a result, the likelihood that fixation of the coils 3 to the slot 23 is weakened can be reduced. Since the entire surfaces of the insulating member 4 on the coils 3 side are fixed to the coils 3, the likelihood that the coils 3 move with respect to the insulating member 4 can be reduced. Furthermore, since the insulating member 4 and the coils 3 are fitted into the slot 23 in a press-fitted state, the likelihood that the coils 3 wobble in the slot 23 can be reduced without using an adhesive. In addition, since the insulating member 4 includes resin, the likelihood that the insulating member 4 is damaged when press-fitted into the slot 23 can be reduced. In addition, since the insulating member 4 is molded in a state of surrounding the coils 3, the likelihood that the insulating films of the coils 3 are damaged can be reduced. Furthermore, in the present embodiment, since the refrigerant flow path is not provided between the surface of the insulating member 4 on the coil 3 side and the coil 3, the likelihood of weakening fixation of the coils 3 to the slot 23 can be further reduced.

Since the side surface portion 41a provided with the groove 44 faces all the coils 3 inserted into one slot 23, the likelihood that more coils 3 are efficiently cooled can be increased by cooling the side surface portion 41a by the refrigerant flowing in the groove 44.

Since the groove 44 is a bottomed groove, contact area between the coils 3 and the insulating member 4 can be increased. As a result, the likelihood that the coils 3 move with respect to the insulating member 4 can be further reduced, and the likelihood that the coils 3 wobble in the slot 23 can be further reduced. Since the groove 44 is a bottomed groove, the insulating member 4 can be interposed between the groove 44 and the coils 3. As a result, the likelihood that insulation between the coils 3 and the stator core 2 is secured can be increased.

Since the groove 44 meanders, the flow path 5 formed by the groove 44 can be lengthened, and the likelihood that the coil 3 is efficiently cooled can be further increased. In particular, since the groove 44 extends across all the coils 3 in the first part 44a, the second part 44b, and the third part 44c, in other words, faces all the coils 3 in the direction perpendicular to both the axial direction and the radial direction, the likelihood that all the coils 3 are efficiently cooled can be increased. In addition, since the direction in which the groove 44 extends while meandering is the axial direction, the likelihood that the coils 3 are efficiently cooled over a wide range in the axial direction can be increased. Since the groove 44 is provided over the entire range in the axial direction of the insulating member 4, the likelihood that the coils 3 are cooled over the wide range in the axial direction can be further enhanced.

Since the groove 44 meanders, it is possible to widen the radial range of the side surface portion 41a in which the groove 44 is not formed in the cross section perpendicular to the axial direction. As a result, the likelihood that the coils 3 and the slot 23 are firmly fixed can be increased. In addition, the likelihood that insulation between the coils 3 and the stator core 2 is secured can be increased.

The groove 44 includes the introduction portion 44d into which the refrigerant from the stator core 2 is introduced at an intermediate position between one end and the other end of the groove 44 in the axial direction. That is, the refrigerant is supplied to the groove 44 from the intermediate position in the axial direction, and flows toward both sides in the axial direction. According to this, as compared with a case where the refrigerant is supplied to one end portion of the groove 44 in the axial direction and flows out from the other end portion of the groove 44 in the axial direction, the distance from the point where the refrigerant is supplied to the groove 44 to the point where the refrigerant flows out can be shortened. As a result, it is possible to reduce the likelihood that the difference in cooling efficiency of the coils 3 between positions in the axial direction increases.

### (2) Second Embodiment

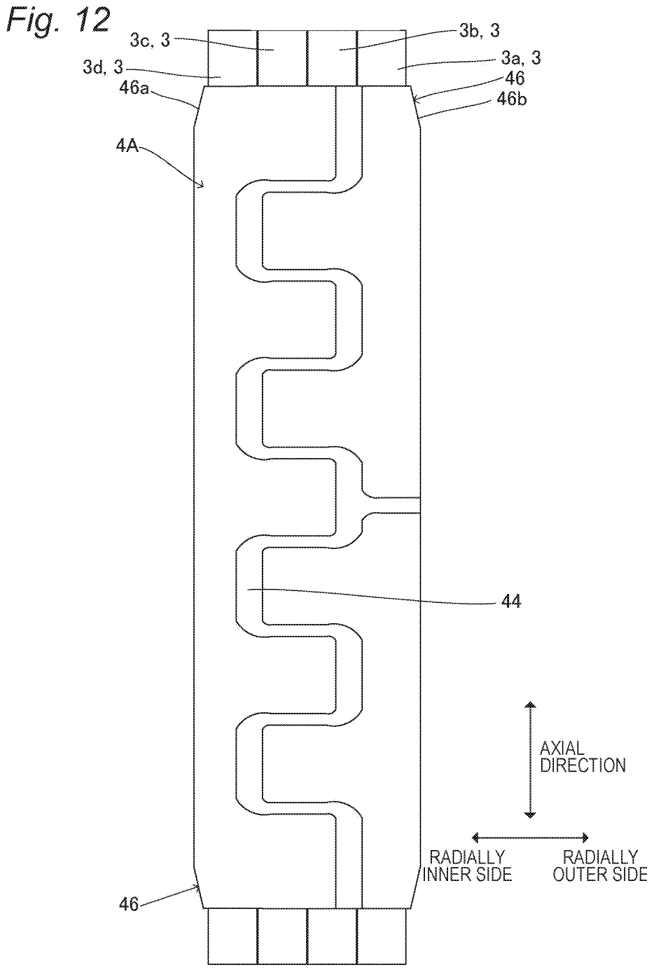

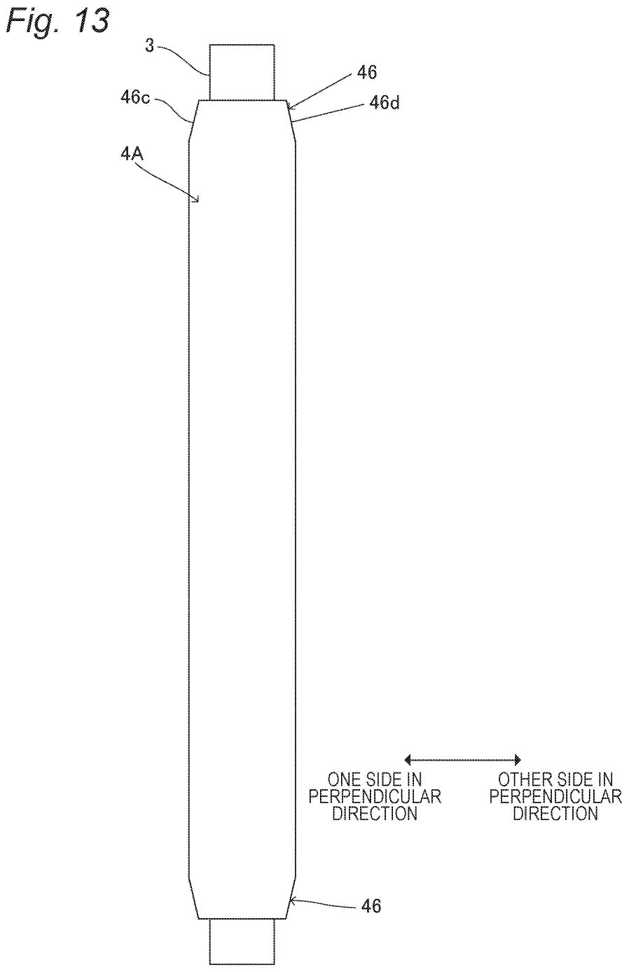

Next, a second embodiment of the present disclosure will be described focusing on portions different from those of the first embodiment. FIG. 12 illustrates a schematic view of an insulating member 4A and the coils 3 in the present embodiment as viewed from the direction perpendicular to both the axial direction and the radial direction. FIG. 13 illustrates a schematic view of the insulating member 4A and the coil 3 of the present embodiment as viewed from a direction from the radially inner side to the radially outer side. In FIGS. 12 and 13, components similar to those of the first embodiment are denoted by the same reference signs, and the description thereof will be omitted as appropriate. In the present embodiment, the insulating member 4A is different from the insulating member 4 of the first embodiment. A stator of the present embodiment is configured similarly to the stator 1 of the first embodiment except for the insulating member 4A. In addition, the stator of the present embodiment is manufactured in a procedure similar to that of the stator 1 of the first embodiment.

The insulating member 4A has tapered portions 46 on the distal end sides in the axial direction. The tapered portions 46 are provided on both sides in the axial direction. A surface of the insulating member 4 on a side opposite to the side where the coil 3 is provided is defined as an outer surface. As illustrated in FIG. 12, in the tapered portion 46, the width between an outer surface 46a facing radially inward and an outer surface 46b facing radially outward gradually decreases toward the most distal end in the axial direction. The outer surfaces 46a and 46b are formed as surfaces inclined with respect to the axial direction. Note that the outer surface 46b is a surface on the slot back surface side. The outer surface 46a is a surface on the slot's radially inner opening side.

A direction perpendicular to both the axial direction and the radial direction is defined as a perpendicular direction. As illustrated in FIG. 13, in the tapered portion 46, the width between an outer surface 46c facing one side in the perpendicular direction and an outer surface 46d facing the other side in the perpendicular direction gradually decreases toward the most distal end in the axial direction. The outer surfaces 46c and 46d are formed as surfaces inclined with respect to the axial direction. Note that the outer surface 46c is a surface on the one of the slot side surfaces side. The outer surface 46d is a surface on the other slot side surface side. The insulating member 4A is configured similarly to the insulating member 4 of the first embodiment except for the tapered portions 46.

In the present embodiment, in addition to the effects similar to those of the first embodiment, since the tapered portions 46 are provided on the distal end sides in the axial direction of the insulating member 4A, insertion of the insulating member 4A into the slot is facilitated. Since the tapered portions 46 are provided on both sides in the axial direction, the insulating member 4A can be easily inserted into the slot from either one side or the other side of the insulating member 4A in the axial direction. Since the tapered portion 46 is formed in a tapered shape when viewed from the direction of FIG. 12, it is easy to insert a back surface portion and a front surface portion of the insulating member 4A into the slot. Furthermore, since the tapered portion 46 is formed in a tapered shape even when viewed from the direction of FIG. 13, it is easy to insert both side surface portions of the insulating member 4A into the slot.

Note that the tapered portion 46 may be formed only on one side of the insulating member 4A in the axial direction. In this case, the insulating member 4A may be inserted into the slot from the side where the tapered portion 46 is formed. In addition, for example, the tapered portion 46 may be formed in a tapered shape when viewed from the direction of FIG. 12, and may not be formed in a tapered shape when viewed from the direction of FIG. 13. For example, the tapered portion 46 may be formed in a tapered shape when viewed from the direction of FIG. 13, and may not be formed in a tapered shape when viewed from the direction of FIG. 12. Furthermore, one of the outer surfaces 46a and 46b in FIG. 12 may be formed as a surface inclined with respect to the axial direction, and the other may be formed as a surface parallel to the axial direction. Moreover, one of the outer surfaces 46c and 46d in FIG. 13 may be formed as a surface inclined with respect to the axial direction, and the other may be formed as a surface parallel to the axial direction.

### (3) Third Embodiment

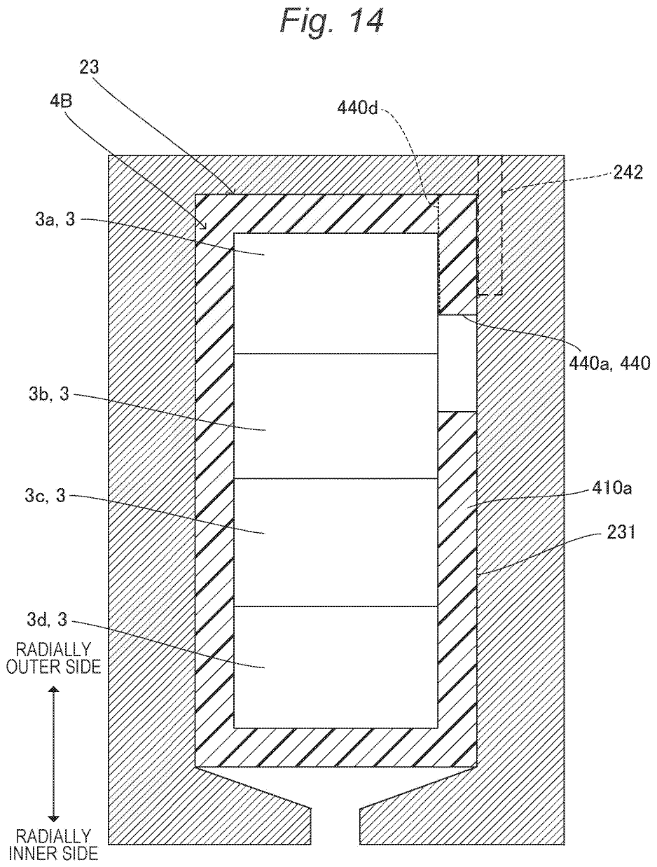

Next, a third embodiment of the present disclosure will be described focusing on portions different from those of the first and second embodiments. FIGS. 14 to 16 are cross-sectional views of the slot 23, the coils 3, and an insulating member 4B of the present embodiment, the cross-sectional views being perpendicular to the axial direction. FIGS. 14 to 16 are cross-sectional views at different positions in the axial direction. In FIGS. 14 to 16, components similar to those of the first and second embodiments are denoted by the same reference signs, and the description thereof will be omitted as appropriate.

A stator of the present embodiment is similar to that of the first embodiment except that the insulating member 4B is different from the insulating member 4 of the first embodiment. In addition, the stator of the present embodiment is manufactured in a procedure similar to that of the stator 1 of the first embodiment. The insulating member 4B includes a side surface portion 410a facing the one of the slot side surfaces 231. A groove 440 is formed in a facing surface of the side surface portion 410a, the facing surface facing the slot side surface 231. The groove 440 is formed as a through groove penetrating between the surface of the insulating member 4B on the slot side surface 231 side and the surface of the insulating member 4B on the coil 3 side. That is, the outer peripheral surfaces of the coils 3 are exposed in the groove 440. A space surrounded by the inner surfaces of the groove 440, the slot side surface 231, and the outer peripheral surfaces of the coils 3 is a refrigerant flow path. The groove 440 is different from the groove 44 of the first embodiment in that the groove 440 is formed as a through groove, and is formed similarly to the groove 44 except for that.

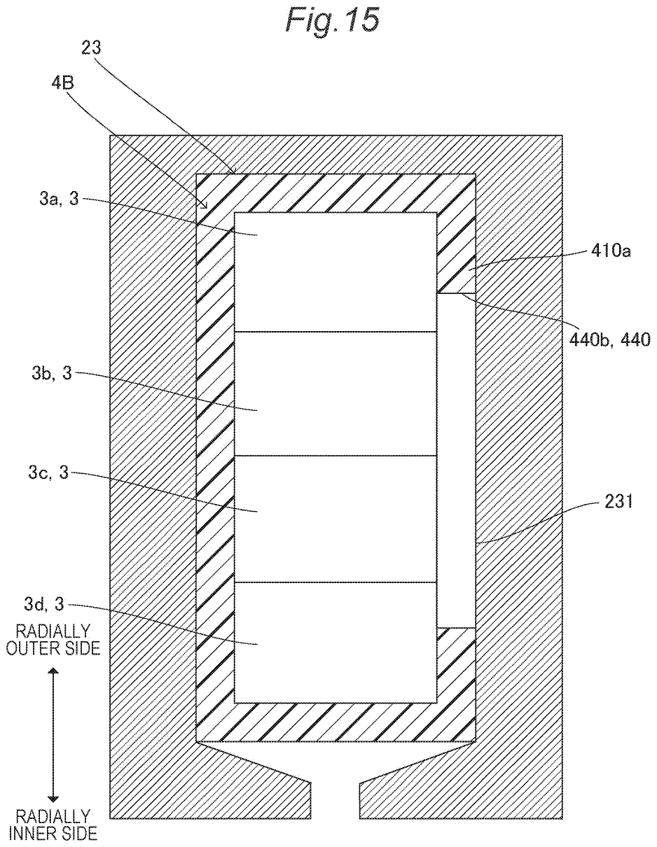

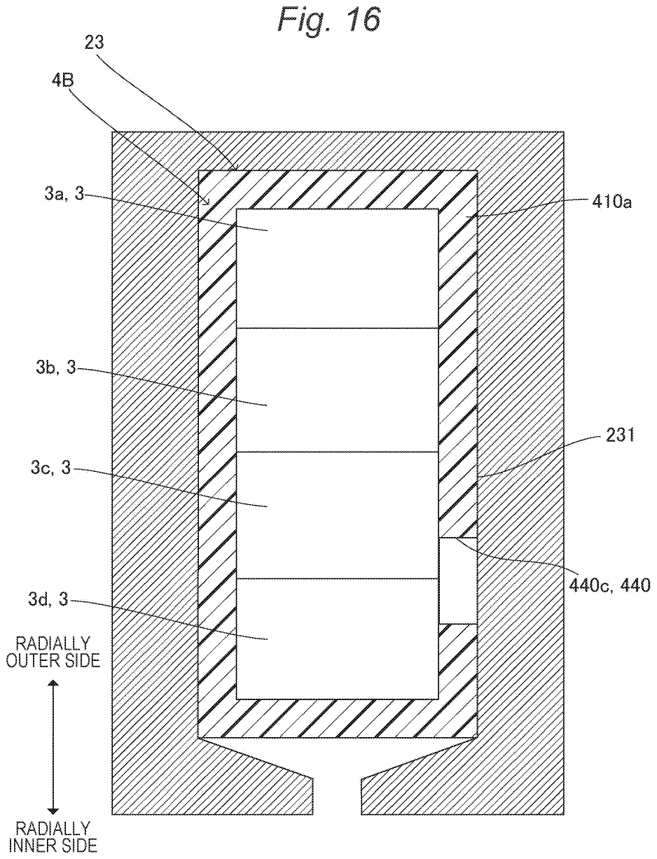

Specifically, the groove 440 meanders. Specifically, the groove 440 has a shape in which a first part 440a (see FIG. 14) extending in parallel with the axial direction, a second part 440b (see FIG. 15) extending in parallel with the radial direction from an end portion of the first part 440a, and a third part 440c (see FIG. 16) extending in parallel with the axial direction from an end portion of the second part 440b opposite to an end portion to which the first part 440a is connected are repeated along the axial direction. Each of the first part 440a, the second part 440b, and the third part 440c is formed as a through groove.

The groove 440 includes, at a central position in the axial direction, an introduction portion 440d (see FIG. 14) into which the refrigerant from the radial flow path 242 of the stator core 2 is introduced. The introduction portion 440d is formed as, for example, a through groove that penetrates between the surface of the side surface portion 410a on the slot side surface 231 side and the surface of the side surface portion 410a on the coil 3 side, but may be formed as a bottomed groove that does not penetrate. The insulating member 4B is configured similarly to the insulating member 4 of the first embodiment except for the groove 440.

In the present embodiment, in addition to obtaining the effects similar to those of the first and second embodiments, since the groove 440 is provided as a through groove, the refrigerant flowing through the groove 440 can be brought into direct contact with the coils 3. In addition, the flow path surrounded by the inner surfaces of the groove 440 and the slot side surface 231 can be enlarged. As a result, the likelihood that the coils 3 are efficiently cooled can be increased.

### (4) Fourth Embodiment

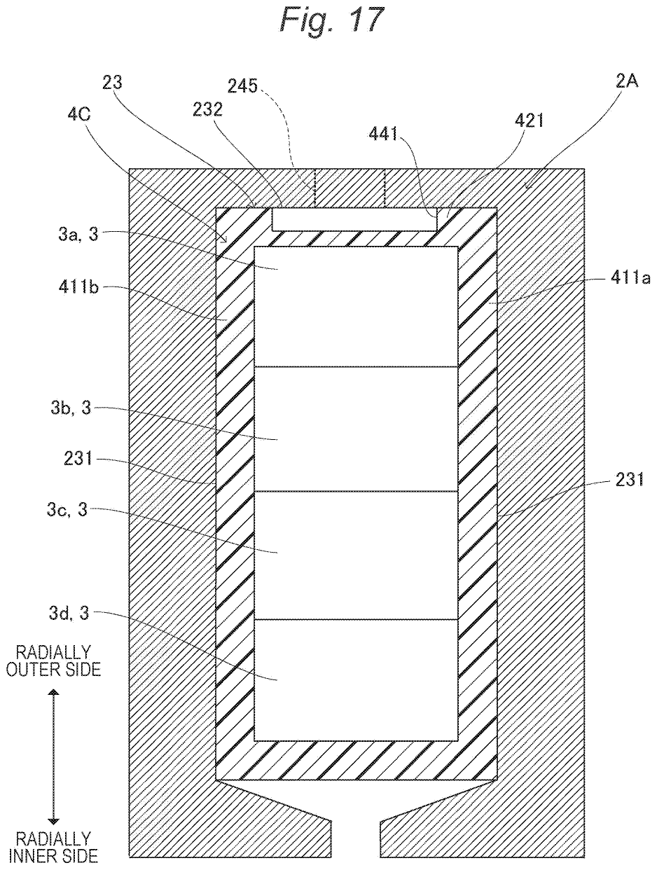

Next, a fourth embodiment of the present disclosure will be described focusing on portions different from those of the first to third embodiments. FIG. 17 is a cross-sectional view of the slot 23, the coils 3, and an insulating member 4C of the present embodiment, the cross-sectional view being perpendicular to the axial direction. In FIG. 17, components similar to those of the first to third embodiments are denoted by the same reference signs, and the description thereof will be omitted as appropriate. A stator of the present embodiment is similar to that of the first embodiment except that the insulating member 4C and a stator core 2A are different from the insulating member 4 and the stator core 2 of the first embodiment. In addition, the stator of the present embodiment is manufactured in a procedure similar to that of the stator 1 of the first embodiment.

The insulating member 4C includes a back surface portion 421 facing the slot back surface 232. A groove 441 is formed in a facing surface of the back surface portion 421, the facing surface facing the slot back surface 232. The groove 441 is formed as a bottomed groove that does not penetrate between the surface of the back surface portion 421 on the slot back surface 232 side and the surface of the back surface portion 421 on the coil 3 side. A space surrounded by the inner surfaces of the groove 441 and the slot back surface 232 is a refrigerant flow path. The groove 441 extends in the axial direction, and specifically, for example, is provided so as to penetrate the insulating member 4C in the axial direction. The cross-sectional shape of the groove 441 perpendicular to the axial direction is, for example, the same shape at any position in the axial direction, but may change along the axial direction. In addition, the groove 441 may meander, for example.

The insulating member 4C includes two side surface portions 411a and 411b facing the slot side surfaces 231. No groove serving as a refrigerant flow path is formed in each of the side surface portions 411a and 411b. Entirety of the side surface portions 411a and 411b function as side surface inner portions provided on the radially inner side of the groove 441. The facing surfaces of the side surface portions 411a and 411b, the facing surfaces facing the slot side surfaces 231, are in contact with the slot side surfaces 231. The groove 441 and the space on the radially inner side of the coil 3 are blocked by the side surface portions 411a and 411b. As a result, the likelihood that the refrigerant flowing through the groove 441 leaks into the space radially inside the coil 3 can be reduced, in other words, the likelihood that the refrigerant leaks to the outside of the stator can be reduced. The insulating member 4C is configured similarly to the insulating member 4 of the first embodiment except for the above.

The stator core 2A includes a flow path 245 that supplies the refrigerant to the groove 441. The flow path 245 is connected to the groove 441 at an intermediate position between one end and the other end of the groove 441 in the axial direction. The flow path 245 and the groove 441 are connected at a central position where the stator core 2A is substantially equally divided into two in the axial direction. A portion of the groove 441 facing the flow path 245 functions as an introduction portion into which the refrigerant from the stator core 2A is introduced. The stator core 2A is configured similarly to the stator core 2 of the first embodiment except for the above.

In the present embodiment, in addition to the effects similar to those of the first to third embodiments, the likelihood that the refrigerant flowing through the groove 441 leaks into the space radially inside the coils 3 can be further reduced because the groove 441 serving as the refrigerant flow path is provided in the back surface portion 421 located radially outside the coils 3. In addition, since the groove 441 is formed as a bottomed groove, contact area between the coils 3 and the insulating member 4C can be increased. As a result, the likelihood that the coils 3 move with respect to the insulating member 4C can be further reduced, and the likelihood that the coils 3 wobble in the slot 23 can be further reduced. In addition, since the groove 441 is a bottomed groove, the insulating member 4C can be interposed between the groove 441 and the coil 3. As a result, it is possible to increase the likelihood that insulation between the coils 3 and the stator core 2A is secured.

### (5) Fifth Embodiment

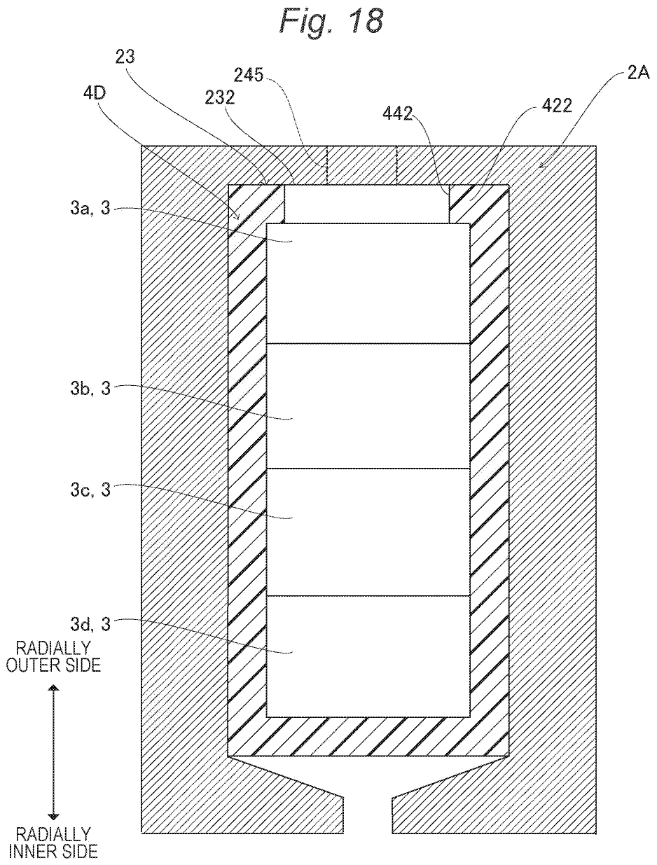

Next, a fifth embodiment of the present disclosure will be described focusing on portions different from those of the first to fourth embodiments. FIG. 18 is a cross-sectional view of the slot 23, the coils 3, and an insulating member 4D of the present embodiment, the cross-sectional view being perpendicular to the axial direction. In FIG. 18, components similar to those of the first to fourth embodiments are denoted by the same reference signs, and the description thereof will be omitted as appropriate. A stator of the present embodiment is similar to that of the first embodiment except that the insulating member 4D and the stator core 2A are different from the insulating member and the stator core 2 of the first embodiment. In addition, the stator of the present embodiment is manufactured in a procedure similar to that of the stator 1 of the first embodiment.

The present embodiment is a modification of the fourth embodiment. Specifically, a groove 442, which is formed in a back surface portion 422 of the insulating member 4D and serves as a refrigerant flow path, is configured as a through groove penetrating between the surface of the back surface portion 422 on the slot back surface 232 side and the surface of the back surface portion 422 on the coil 3 side. The coil 3 is exposed in the groove 442. The insulating member 4D is configured similarly to the insulating member 4C of the fourth embodiment except for the groove 442. The stator core 2A is configured similarly to the stator core 2A of the fourth embodiment.

In the present embodiment, in addition to obtaining the effects similar to those of the first to fourth embodiments, since the groove 442 is provided as a through groove, the refrigerant flowing through the groove 442 can be brought into direct contact with the coil 3. In addition, the flow path surrounded by the inner surfaces of the groove 442 and the slot back surface 232 can be enlarged. As a result, the likelihood that the coils 3 are efficiently cooled can be increased.

### (6) Other Embodiments

In the above embodiments, an example has been described in which the refrigerant is supplied into the slot from the central position in the axial direction. However, the present disclosure is not limited thereto, and the refrigerant may be supplied into the slot, that is, into the groove of the insulating member from an intermediate position other than the central position between one end portion and the other end portion of the stator core in the axial direction. That is, the introduction portion of the groove into which the refrigerant from the stator core is introduced may be provided at an intermediate position other than the central position between one end and the other end of the groove in the axial direction. In addition, the refrigerant may be supplied into the groove of the insulating member from one end portion side of the stator core, and the refrigerant may flow out from the other end portion side of the stator core.

It is sufficient if the stator core is an annular member having a plurality of teeth arranged in the circumferential direction and a plurality of slots formed between the teeth in the circumferential direction. That is, in the stator core, it is sufficient if a plurality of slots are formed by a plurality of teeth and a coil is disposed in each slot. Then, it is sufficient if a rotor can rotate relative to the stator by an interaction between the magnetic field formed by the coil and the magnetic field formed by the rotor. Alternatively, it is sufficient if a current is generated in the wiring of the stator by a change in the magnetic field generated by rotation of the rotor. In the stator core, the number of magnetic poles, the number of slots, the material, and the like may have various configurations. The slot side surface may not be provided in parallel with the radial direction of the stator core. In this case, the side surface portion of the insulating member may not be provided in parallel with the radial direction.

It is sufficient if the stator core is annular as a whole. The shapes of the radially inner surface and the radially outer surface of the ring formed by the stator core are not limited. For example, the radially outer surface may have a circular shape or a polygonal shape when viewed from the axial direction. The teeth are formed in the radially inner surface, and the slot is formed between the teeth. In the stator core, a schematic shape including the teeth can be regarded as an annular shape, and a portion excluding the teeth can be regarded as an annular shape. In addition, the stator of the present disclosure may be applied to an electric motor (motor), which is a type of rotary electric machine, or may be applied to a generator.

The insulating member may include rubber. In this case, in step S115 of FIG. 7, rubber (synthetic rubber or natural rubber) may be filled around the coil inserted into the cavity of the mold.

It is sufficient if a groove is formed in the facing surface of the insulating member, the facing surface facing the wall surface of the slot. The shape of the groove is not limited. The groove may not meander. In this case, for example, the groove may linearly extend in the axial direction in the side surface portion of the insulating member. In addition, the first part 44a or the third part 44c of the groove 44 in FIG. 2 may extend so as to be displaced in the radial direction as proceeding in the axial direction. The second part 44b of the groove 44 may extend so as to be displaced in the axial direction as proceeding in the radial direction. Similarly, the first part 440a of the groove 440 in FIG. 14 or the third part 440c in FIG. 16 may extend so as to be displaced in the radial direction as proceeding in the axial direction. The second part 400b in FIG. 15 may extend so as to be displaced in the axial direction as proceeding in the radial direction.

A plurality of grooves of the insulating member may be formed separately from each other. For example, a plurality of grooves separated from each other, the plurality of grooves facing the plurality of coils, respectively, may be formed in the side surface portion of the insulating member. The plurality of grooves in this case may extend in the axial direction. Each of the plurality of grooves serves as a refrigerant flow path. In the stator core, a flow path for supplying a refrigerant to each of the plurality of grooves is formed. In addition, in a case where the groove of the insulating member meanders, the direction in which the groove extends while meandering may be the radial direction. The grooves of the insulating member may be provided in both of the two side surface portions. The grooves may be provided in both of the side surface portion and the back surface portion.

The groove of the insulating member may be formed only in a partial section of the insulating member in the axial direction. In this case, the stator core may be provided with refrigerant flow paths connected to both ends in the axial direction of the groove of the insulating member.

It is sufficient if the insulating member includes resin or rubber and is provided so as to surround the coil in the slot. The resin or rubber insulating member may be provided so as to surround the coil by a method other than integral molding with the coil. For example, a frame-shaped insulating member may be formed first, and then the coil may be inserted inside the frame-shaped insulating member. In this case, fitting between the insulating member and the coil may be set to a loose fitting to such an extent that the insulating film of the coil is not damaged. In this case, the insulating member and the coil may be fixed by, for example, an adhesive.

Further, in the method of manufacturing the stator of the present disclosure, the step of inserting the insulating member and the coil that are integrated into the slot may be a step of not press-fitting the insulating member and the coil. That is, fitting between the slot and the insulating member and the coil may be a clearance fit or a transition fit. In this case, the insulating member and the slot may be fixed by, for example, an adhesive.

Further, for example, in a case where the space on the radially inner side of the coil in the slot is set as a refrigerant flow path, the groove serving as the refrigerant flow path formed in the insulating member may communicate with the space (flow path) on the radially inner side of the coil.

In addition, in the above embodiment, the example has been described in which the molding step of molding the insulating member including resin or rubber and surrounding the coil to integrate the coil and the insulating member and the flow path forming step of providing the refrigerant flow path in the insulating member are the same step. However, the present disclosure is not limited thereto, and the flow path forming step may be performed after the molding step. In this case, in the molding step, an insulating member having no groove serving as a flow path is molded around the coil. Thereafter, in the flow path forming step, a groove serving as a flow path is formed in the insulating member. In this case, the groove may be formed by any method such as cutting of the insulating member.

Further, in the method of manufacturing the stator of the present disclosure, it is sufficient if the flow path forming step includes providing the refrigerant flow path in the insulating member molded so as to surround the coil. That is, the shape of the flow path provided in the flow path forming step, the position of the flow path in the insulating member, or the like is not limited. For example, a groove serving as a refrigerant flow path may be provided in a surface of the insulating member on the coil side. The groove may be a bottomed groove that does not penetrate between the surface of the insulating member on the slot wall surface side and the surface of the insulating member on the coil side.
<1> A stator includes: an annular stator core that has a plurality of teeth that are arranged in a circumferential direction and protrude radially inward, and a plurality of slots that are formed between the plurality of teeth in the circumferential direction; a coil that is disposed in each of the plurality of slots; and an insulating member that includes resin or rubber, surrounds the coil in the each of the plurality of slots, and is fitted into the each of the plurality of slots in a press-fitted state, wherein a groove is formed in a facing surface of the insulating member, the facing surface facing a wall surface of the each of the plurality of slots, and a space surrounded by an inner surface of the groove and the wall surface of the each of the plurality of slots is a refrigerant flow path.

With such a configuration, the groove is formed in the facing surface of the insulating member that includes resin or rubber, the facing surface facing the wall surface of the slot, and the space surrounded by the inner surface of the groove and the wall surface of the slot is used as the refrigerant flow path. As a result, the likelihood that the coil is efficiently cooled can be increased. In addition, since the groove serving as the flow path is formed in the facing surface of the insulating member on the slot's wall surface side, the contact area between the insulating member and the coil can be easily secured, and the likelihood that fixation of the coil to the slot is weakened can be reduced.
<2> In the stator, the wall surface of the each of the plurality of slots includes side surfaces that extend in a radial direction of the annular stator core and a back surface that connects end portions of the side surfaces on a radially outer side, and the groove is provided in a side surface portion of the insulating member, the side surface portion facing one of the side surfaces of the each of the plurality of slots or a back surface portion of the insulating member, the back surface portion facing the back surface of the each of the plurality of slot.
<3> In the stator, the wall surface of the each of the plurality of slots includes a side surface that extends in a radial direction of the annular stator core, the insulating member includes a side surface portion facing the side surface of the each of the plurality of slots, the side surface portion includes a side surface inner portion provided on a radially inner side of the groove, and the facing surface of the side surface inner portion is in contact with the side surface of the each of the plurality of slots.
<4> In the stator, the groove meanders.
<5> In the stator, the groove extends in an axial direction, and includes an introduction portion into which a refrigerant from the annular stator core is introduced at an intermediate position between one end and another end of the groove in the axial direction.
<6> In the stator, surfaces of the insulating member on sides opposite to a side where the coil is provided are defined as outer surfaces, and a width between the outer surfaces on a distal end side in an axial direction of the insulating member gradually decreases toward a most distal end of the insulating member in the axial direction.
<7> A method of manufacturing a stator includes: a molding step of molding an insulating member that includes resin or rubber and surrounds a coil to integrate the coil and the insulating member; a flow path forming step of providing a refrigerant flow path in the insulating member; and an inserting step of inserting the insulating member in which the refrigerant flow path is provided and the coil into each of a plurality of slots of an annular stator core having a plurality of teeth that are arranged in a circumferential direction and protrude radially inward and the plurality of slots that are formed between the plurality of teeth in the circumferential direction.

With such a configuration, since the insulating member including resin or rubber is molded so as to surround the coil to integrate the coil and the insulating member, the likelihood that the coil and the insulating member are firmly fixed can be increased. As a result, the likelihood that fixation of the coil to the slot is weakened can be reduced. In addition, since the insulating member is provided with the refrigerant flow path, the likelihood that the coil is efficiently cooled can be increased.
<8> In the method, the inserting step is a step of press-fitting the insulating member and the coil into the each of the plurality of slots.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A stator comprising:
an annular stator core that has a plurality of teeth that are arranged in a circumferential direction and protrude radially inward, and a plurality of slots that are formed between the plurality of teeth in the circumferential direction;
a coil that is disposed in each of the plurality of slots; and
an insulating member that includes resin or rubber, surrounds the coil in the each of the plurality of slots, and is fitted into the each of the plurality of slots in a press-fitted state,
wherein a groove is formed in a facing surface of the insulating member, the facing surface facing a wall surface of the each of the plurality of slots, and
a space surrounded by an inner surface of the groove and the wall surface of the each of the plurality of slots is a refrigerant flow path.

2. The stator according to claim 1,
wherein the wall surface of the each of the plurality of slots includes side surfaces that extend in a radial direction of the annular stator core and a back surface that connects end portions of the side surfaces on a radially outer side, and
the groove is provided in a side surface portion of the insulating member, the side surface portion facing one of the side surfaces of the each of the plurality of slots or a back surface portion of the insulating member, the back surface portion facing the back surface of the each of the plurality of slot.

3. The stator according to claim 1,
wherein the wall surface of the each of the plurality of slots includes a side surface that extends in a radial direction of the annular stator core,
the insulating member includes a side surface portion facing the side surface of the each of the plurality of slots,
the side surface portion includes a side surface inner portion provided on a radially inner side of the groove, and
the facing surface of the side surface inner portion is in contact with the side surface of the each of the plurality of slots.

4. The stator according to claim 1, wherein the groove meanders.

5. The stator according to claim 1, wherein the groove extends in an axial direction, and includes an introduction portion into which a refrigerant from the annular stator core is introduced at an intermediate position between one end and another end of the groove in the axial direction.

6. The stator according to claim 1,
wherein surfaces of the insulating member on sides opposite to a side where the coil is provided are defined as outer surfaces, and
a width between the outer surfaces on a distal end side in an axial direction of the insulating member gradually decreases toward a most distal end of the insulating member in the axial direction.

7. A method of manufacturing a stator comprising:
a molding step of molding an insulating member that includes resin or rubber and surrounds a coil to integrate the coil and the insulating member;
a flow path forming step of providing a refrigerant flow path in the insulating member; and
an inserting step of inserting the insulating member in which the refrigerant flow path is provided and the coil into each of a plurality of slots of an annular stator core having a plurality of teeth that are arranged in a circumferential direction and protrude radially inward and the plurality of slots that are formed between the plurality of teeth in the circumferential direction.

8. The method of manufacturing the stator according to claim 7, wherein the inserting step is a step of press-fitting the insulating member and the coil into the each of the plurality of slots.
